(19) United States
(12) Patent Application Publication
(10) Pub. No.: US 2013/0210163 A1
(43) Pub. Date: Aug. 15, 2013

(54) ANALYSIS

(71) Applicants: Andrew Hopwood, Solihull (GB); Nina Moran, Solihull (GB); Pieris Koumi, Solihull (GB); John Lee-Edghill, Solihull (GB)

(72) Inventors: Andrew Hopwood, Solihull (GB); Nina Moran, Solihull (GB); Pieris Koumi, Solihull (GB); John Lee-Edghill, Solihull (GB)

(73) Assignees: The Arizona Board of Regents Acting for and on behalf of University of Arizona, Tucson, AZ (US); FORENSIC SCIENCE SERVICE LIMITED, Birmingham (GB)

(21) Appl. No.: 13/819,403

(22) PCT Filed: Aug. 24, 2011
(86) PCT No.: PCT/GB2011/051591

§ 371 Date: Apr. 15, 2013

(30) Foreign Application Priority Data
Aug. 27, 2010 (GB) 1014335.2

(51) Int. Cl. G01N 1/28

(52) U.S. Cl. CPC G01N 1/28
USPC 436/174; 422/430

(57) ABSTRACT

A method for collecting a sample and/or analysing a sample is provided, together with kits for use therein, in which the method includes using the kit and wherein an identifier is provided on one or more of the devices and/or containers and/or packaging which can be recorded and which is used to link the identity of the identifier for one or more of those identifiers to one or more of the identities for one or more of the other identifiers. In this way, the different devices, containers, pieces of equipment, reagents and stages used in the collection and/or analysis can be linked together for future reference. This ensures the correct processing of the sample and the correct attributing of the end results to it. Checks or other enquiries can be made on each of the different devices etc to validate the results if necessary.

This invention concerns improvements in and relating to analysis, particularly, but not exclusively, in relation to biological samples.

The present invention has amongst its aims to provide an analysis process which generates better results and/or more reliable results and/or reliable results using a lower level of training and/or qualification and/or experience.

According to a first aspect of the invention there is provided a method of analysing a sample, the method comprising one or more of: a sample collection stage and/or sample preparation stage and/or sample loading stage and/or cartridge loading stage and/or analysis stage and/or results stage and/or results transmission stage and/or result processing stage and/or processed results transmission stage and/or processed results consideration stage and/or database or records modification stage and/or results based action stage.

According to a second aspect of the invention there is provided apparatus for the analysis of a sample, the apparatus including one or more parts for providing one or more of: a sample collection stage and/or sample preparation stage and/or sample loading stage and/or cartridge loading stage and/or analysis stage and/or results stage and/or results transmission stage and/or result processing stage and/or processed results transmission stage and/or processed results consideration stage and/or database or records modification stage and/or results based action stage.

The one or more parts may include one or more instruments and/or one or more loadable elements, such as a cartridge, and/or one or more sample collection devices and/or one or more sample preparation components and/or one or more data processors and/or one or more datasets and/or one or more data transmitters and/or one or more data receivers.

According to a third aspect of the invention there is provided a kit for use in collecting a sample, the kit including:

packaging for one or more devices or containers; and

one or more devices and/or one or more containers.

According to a fourth aspect of the invention there is provided a kit for use in analysing a sample, the kit including:

packaging for one or more items, the one or more items including a loadable element in which at least a part of the analysis of the sample is performed.

The loadable element may be a cartridge.

According to a fifth aspect of the invention there is provided apparatus for the monitoring an instrument, the apparatus including one or more elements which are provided in the instrument.

The one or more elements may be provided in the instrument by loading the one or more elements to a position occupied by a loadable element or cartridge during the use of the instrument to analyse a sample.

According to a sixth aspect of the invention there is provided a method for monitoring an instrument, the method including:

providing one or more monitoring steps, at least one of the monitoring steps including a calibration step and/or diagnostic step and/or control step.

The various aspects of the invention may include any of the following features, options or possibilities in any combination.

The process may include a sample collection stage and/or sample preparation stage and/or sample loading stage and/or cartridge loading stage and/or analysis stage and/or results stage and/or results transmission stage and/or result processing stage and/or processed results transmission stage and/or processed results consideration stage and/or database or records modification stage and/or results based action stage.

One or more or each of the abovementioned stages may be computer implemented and/or include one or more operations which are computer implemented.

The process may include providing an identifier on one or more of the items used in a sample collection stage and/or sample preparation stage and/or sample loading stage and/or cartridge loading stage and/or analysis stage and/or results stage and/or results transmission stage and/or result processing stage and/or processed results transmission stage and/or processed results consideration stage and/or database or records modification stage and/or results based action stage.

The items may include physically items, such as containers, instruments or loaded elements therefore, such as cartridges. The terms loaded element and cartridge are used interchangeably herein. The items may include data items, such as records, files or datasets. The items may include a person.

The identity of the identifier for one or more of those identifiers may be recorded. The identity of the identifier for one or more of those identifiers may be linked to one or more of the identities for one or more of the other identifiers.

Preferably the identity of the identifier is recorded for two or more of the record of the person providing the sample, the sample collection device, the sample preparation container, the cartridge for analysing the sample, a record of the results of the analysis, a record of the processed results or a record arising from the modification stage. Preferably three or more or four or more of these are recorded.

Preferably the identity of the identifier is linked for two or more of the record of the person providing the sample, the sample collection device, the sample preparation container, the cartridge for analysing the sample, a record of the results of the analysis, a record of the processed results or a record arising from the modification stage. Preferably three or more or four or more of these are linked.

In the sample collection stage the sample may be collected from a person. In the sample collection stage the sample may be collected from a location, for instance a crime scene.

The sample collection stage may use a sample collection device. The sample collection device may be a fibrous material and/or swab, for instance a buccal swab. The sample collection device may include a matrix provided with one or more sample modifying reagents, for instance lysis reagents.

The sample collection stage may include placing a sample collection device in a container. The container may be used for the storage and/or transportation of the sample.

The item or items needed for the sample collection stage may be provided in a sample collection kit.

The sample collection kit may include one or more sample collection devices and one or more containers. Preferably a sample collection device and a container is provided, with the container suitable for receiving the sample collection device or at least a part thereof on which sample is collected. One or more sample collection device of different types, for instance to collect different sample types may be provided. One or more containers of different types may be provided. One or more different types of sample collection kit may be provided, the kits differing in terms of the sample collection device(s) and/or container(s) provided therein.

The sample collection kit packaging and/or one or more items provided therein may be provided with an identifier. The identity of the identifier may be recorded during the sample collection stage. The identity of the identifier for the sample collection kit packaging may be recorded before the packaging is opened. The identity of the identifier for the sample collection device may be recorded before the device is used to collect a sample and/or after. The identity of the identifier for the container provided in the sample collection kit may be recorded before the sample is collected and/or before the sample collection device is placed in the container and/or after.

The identity of the identifier recorded may be use to link the sample collection kit and/or sample collection device and/or container to the sample and/or to the person providing the sample and/or to a record of information given by or taken from the person providing the sample.

The identifier may be a letter and/or number based identifier. The identifier may be a barcode form identifier. The identifier may be a Bluetooth device, a radio frequency device or the like.

The identity of the identifier on an item may be the same as or include a same part as or be different from the identifier on other items, including those from the sample collection kit.

The identity of the identifier may be collected using a reader and/or may be manually inputted. A reader may be provided at the location where the sample is collected.

The record of information given by or taken from the person providing the sample may include one or more of: the person's identity, details taken from the manner in which they have confirmed their identity, potentially including one or more of drivers licence, passport or other identification, the location the sample was collected at, the time the sample was collected, the date the sample was collected and other identifiers for the person, for instance a fingerprint or photograph. The record of information may include information on the alleged offense, for instance in a code form, date of birth of the person.

The record of information may include an identifier which has its identity recorded and/or which is linked to one or more other items.

The record of information may be provided to one or more databases or record systems.

The identity of the identifier collected from the packaging and/or an item may be considered against valid values therefore. A valid value may apply where the item is within the acceptable date range for its use. An invalid value may apply where the item is outside the acceptable date range for its use. The consideration of the valid values may be provided by the instrument and/or by communication between the instrument and a remote location. An invalid value may trigger a warning to the user, for instance of the reason for the invalid value and/or of the necessary step for the user to take.

In the sample preparation stage may occur at or in transit to the location of the instrument.

The sample preparation step may involve the sample collection device or a part thereof being introduced to a container. The container may provide one or more of the reagents and/or sample preparation aids needed to render the sample to a form suitable for loading to the cartridge.

The sample may be rendered to a suitable form by contacting with water and/or heating and/or incubating and/or centrifuging and/or washing and/or decanting and/or purification. The sample may be rendered to a suitable form by releasing the sample from the sample collection device and/or matrix it is provide on and/or in.

The sample preparation step may be provided within 100 m of the location at which the sample is collected.

The sample preparation step may receive the sample from a sample collection stage provided at another location, for instance a crime scene

The instrument may have a user interface. The user interface may include a keyboard. The user interface may include a number input device. The user interface may include a character recognition device. The character may by a biometric characteristic, such as a fingerprint or iris pattern

The instrument may have a first state and a second state. The instrument may undergo a transition from a first state to a second state on receiving a valid user input, for instance a user log on input, such as a password, pass code, pin code, biometric input or other user identifying and/or user specific input. The user input received may be compared with stored values to establish whether the user input is a valid user input. One or more further inputs may be required for a transition from the first to the second state. The one or more further inputs may include the identity of an identifier provided on one or more items.

In the first state, the instrument may have a first set of possible user interactions. The first set of possible user interactions may consist of or include receiving a user log on input. In the second state, the instrument may have a second set of possible user interactions. The second set of user interactions is preferably greater than the first set of possible user interactions.

In the first state, the instrument may have a first set of possible process steps. The first set of possible process steps may consist of or include receiving a user log on input. In the second state, the instrument may have a second set of possible process steps. The second set of process steps is preferably greater in number of steps than the first set of possible process steps.

Preferably in the first state the opening of a part of the instrument, for instance a cover or lid is prevented by the instrument. Preferably in the first state the loading of a cartridge to the instrument and/or the removal of a cartridge from the instrument is prevented. Preferably in the first state the analysis of a sample using a cartridge is prevented by the instrument.

Preferably in the second state the opening of a part of the instrument, for instance a cover or lid is allowed by the instrument. Preferably in the second state the loading of a cartridge to the instrument and/or the removal of a cartridge from the instrument is allowed by the instrument. Preferably in the second state the analysis of a sample using a cartridge is allowed by the instrument.

An identifier may be provided on the instrument and/or one or more cartridges and/or one or more containers and/or one or more sample containers and/or one or more reagent containers and/or one or more sample collection devices and/or one or more packages, for instance a package containing one or more of the other items.

In the second state, a user may be able to perform one of more tests on the instrument and/or a cartridge therein. The one or more tests may be calibration tests and/or diagnostic tests and/or control tests.

In the first and/or second state a transition to a third state may be possible, for instance on a valid user input being received for the transition.

In a third state, a user may be able to change the valid users for the instrument and/or the software being used by the instrument and/or perform one or more one or more features of the process sequence and/or process conditions. The instrument may store and/or transmit to a remote location and/or generate a hard copy of the changes made.

The instrument may store and/or transmit to a remote location and/or generate a hard copy of the identity of the user logged on to the instrument and/or the time and/or date of the log on. The instrument may store and/or transmit to a remote location and/or generate a hard copy of these details made. The instrument may store and/or transmit to a remote location and/or generate a hard copy of the instrument identity and/or location of the instrument and/or operating form of the instrument, for instance software version, process conditions, process sequence.

An intermediate state may be provided between the first and second state. Transition from the first to the second state and/or from the intermediate state to the second state may be prevented by the instrument when one or more conditions are not met. The one or more conditions may include the continuing authority of the user to conduct analyses and/or the training received by the user and/or the condition of the instrument and/or cartridge. The conditions may be compared with values stored on the instrument and/or at a remote location to see whether they are met. The condition of the instrument and/or cartridge may arise from a consideration made during and/or after the processing of a previous cartridge by the instrument and/or from a consideration made before the processing of a cartridge can commence.

In the sample loading stage a clean cartridge may be loaded with a sample. A connection may be provided between a container containing the sample and the cartridge.

The sample loading stage and/or cartridge loading stage and/or sample analysis stage may use a cartridge. The cartridge may be a single use device. The cartridge may contain a plurality of linked processors, such as chambers. The cartridge may provide for one or more of: sample cleaning, sample purification, normalisation of the amount of one or more components in the sample, amplification of one or more components in the sample and/or denaturing one or more components in the sample and/or a size based separation on one or more components in the sample.

The sample loading stage and/or cartridge loading stage and/or sample analysis stage may use one or more containers to provide one or more reagents or materials to the cartridge.

The item or items needed for the sample loading stage and/or cartridge loading stage and/or sample analysis stage may be provided in a sample analysis kit.

The sample analysis kit may consist of a cartridge in packaging. The packaging for the sample analysis kit and/or sample collection kit or kits may be light proof and/or shrink wrapped and/or prepared in a protected atmosphere and/or be tamper evident and/or be DNA free inside and/or may provide the storage conditions, use by date and/or other relevant information printed on the packaging.

The sample analysis kit is preferably separate from, but may be supplied with the sample collection kit or kits, for instance within an overall kit provided within sealed packaging.

The sample analysis kit packaging and/or one or more items therein may be provided with an identifier. The identity of the identifier may be recorded during the sample preparation and/or sample loading and/or cartridge loading and/or analysis stage. The identity of the identifier for the sample analysis kit may be recorded before the packaging is opened. The identity of the identifier for the cartridge may be recorded before the cartridge is loaded with the sample and/or before the cartridge is loaded into the instrument and/or after.

The identity of the identifier recorded may be used to link the sample analysis kit and/or cartridge and/or container for reagents or materials to one or more of: the sample collection kit, sample collection device, one or more containers in the sample collection kit, sample, person providing the sample or record of information given by or taken from the person providing the sample.

The identifier may be a letter and/or number based identifier. The identifier may be a barcode form identifier. The identifier may be a Bluetooth device, a radio frequency device or the like.

The identity of the identifier on an item may be the same as or include a same part as or be different from the identifier on other items, including those from the sample analysis kit.

The identity of the identifier may be collected using a reader and/or may be manually inputted. A reader may be provided at the location where the sample analysis kit is opened, for instance attached to the instrument.

The identity of the identifier collected from the packaging and/or an item may be considered against valid values therefore. A valid value may apply where the item is within the acceptable date range for its use. An invalid value may apply where the item is outside the acceptable date range for its use. The consideration of the valid values may be provided by the instrument and/or by communication between the instrument and a remote location.

An invalid value may trigger a warning to the user, for instance of the reason for the invalid value and/or of the necessary step for the user to take.

An invalid value may prevent operation of one or more further steps in the sample loading stage and/or cartridge loading stage and/or analysis stage, for instance until an alternative sample analysis kit has been selected, considered and approved. The one or more operations may be prevented by physical access to the route through which the sample is introduced to the cartridge being prevented. The instrument may provide a physical barrier or obstruction to the sample in its sample preparation container being connected to the cartridge and/or introduced to the instrument.

In the cartridge loading stage the cartridge is placed in the instrument.

Preferably the cartridge loading stage is provided before the sample loading stage. The sample loading stage may be provided before the cartridge loading stage.

In the analysis stage the cartridge and instrument are used to process the sample and to extract the results of the processing.

Before the analysis of the sample by the instrument commences, the cartridge and/or instrument may be subject to one or more checks.

The one or more checks may include the time since the cartridge was loaded into the instrument may be monitored. Where the time period exceeds a value, the instrument may prevent the sample being loaded to the cartridge. The process may require an alternative sample analysis kit and/or cartridge to be selected, considered and approved in good time. The one or more checks may include the time since the sample was loaded to a sample preparation container being monitored.

Once the instrument and/or cartridge have been successfully loaded with the sample, the instrument may automatically start the analysis.

During the analysis stage the instrument may automatically log off the user from using the user interface.

During the analysis stage, the instrument may provides an extent of progress indication to the user or other persons.

During the analysis stage, the user and/or any other persons may be prevented from opening a lid or cover on the instrument or otherwise gaining access to the location the sample and/or the cartridge are present at. A restriction may be placed on the user and/or any other person amending or editing the information provided to the instrument by a user.

After or during the analysis stage the instrument may provide an indication of an unsuccessful analysis, for instance if during the analysis the instrument and/or the remote location reaches a conclusion the analysis is or will be unsuccessful, for instance based upon the output from the analysis stage. If an unsuccessful analysis does occur, then a log of that is generated, preferably including one or more of details of the stage the analysis had reached, the nature of the failure and a reason as far as that can be identified. The log may be interpreted by a local user and/or at a remote location.

Before or at the start of the analysis stage, the instrument may conducts a series of pre-analysis checks and diagnostics.

At the end of the analysis stage or in the results stage, the instrument may provide an indication of a successful analysis, for instance if the instrument and/or a remote location reach such a conclusion based upon the output from the analysis.

If the processing of the sample is interrupted, the process may allow the process to be restarted at the same point and/or a previous point in the process. The results for the analysis may include a record of such an interruption and the actions arising.

The user may have the option to stop an analysis part way through. The analysis may be stopped and/or restarted at that point in the analysis process when the stop request is made. The analysis may be stopped and/or restarted at the next allowable point in the analysis process after the stop request is made. The next allowable point may be after the completion of one operation within the cartridge and/or before the start of the next operation within the cartridge. The results for the analysis may include a record of such an interruption and the actions arising. A time limit may apply to the time between stopping the process for a sample and/or cartridge and restarting the process for that sample and/or cartridge.

In the results stage, the instrument may prepare the results for the results transmission stage.

The results may contain a raw results data file generated by the instrument, such as by a capillary electrophoresis analysis. The results may include one or more of the other pieces of information provided to the instrument and/or otherwise recorded in the process, for instance relating to the user or the instrument. The results may be combined with information stored at one or more other locations before dispatch.

The results may include an identity for an identifier for the results. The identity of the identifier included in the results may be used to link the results to one or more of: the sample analysis kit, cartridge, container for reagents or materials, the sample collection kit, sample collection device, one or more containers in the sample collection kit, sample, person providing the sample or record of information given by or taken from the person providing the sample.

In the results transmission stage the results may be transmitted by the instrument. The user may be offered the option of triggering the transmission of the results, but more preferably the transmission of the results occurs automatically.

The results may be transmitted to a remote location relative to the location of the instrument. The remote location could be a central facility which handles the results processing stage for a number of instruments, potentially for a number of different instrument owners and/or users. The remote location may be in excess of 1000 m from the instrument and potentially 10,000 m or more.

The results may be transmitted over one or more telecommunications networks and/or in one or more formats and/or according to one or more protocols. The results may be transmitted to one or more locations with the same organisation and/or building as the instrument.

The results transmission stage may generate and/or provide to the user an indication of successful transmission and/or receipt and/or an indication of an unsuccessful transmission and/or receipt.

The transmission may be to one or more different locations and/or remote locations. Different results content and/or formats may be sent to one or more of the different locations compared with the results content and/or formats sent to one or more other locations. The connection between the instrument and the one or more remote locations may be provided by any telecommunications option, including Internet, mobile telecommunications, such as so called third generation mobile telephone technology or satellite based communication technology.

The instrument and/or a peripheral associated there with may provide a receipt or other form of hard copy confirmation when a successful transmission and/or receipt is achieved. The receipt may include within it and/or on it an identifier to link it to one or more of: the identity of the identifier included in the results, the sample analysis kit, cartridge, container for reagents or materials, the sample collection kit, sample collection device, one or more containers in the sample collection kit, sample, person providing the sample or record of information given by or taken from the person providing the sample.

In the results processing stage the results file is received and subjected to one or more processing steps. The results processing stage may generate one or more processed results, for instance as a result of one or more processing steps.

The processed results may be in the form of one or more reports. Different processed results and/or reports may be generated. Different processed results and/or reports may be transmitted to one or more receipt locations compared with the results content and/or formats sent to one or more other receipt locations.

The one or more processing steps may be provided by computer software operating at the location and/or one of more people at the location.

In the processed results transmission stage the processed results are transmitted. The processed results may be transmitted to the instrument, but it is preferred that they are transmitted to one or more other receipt locations. The receipt locations may be pre-determined and/or may be defined by the content of the processed results. Different processed results and/or contents and/or formats may be sent to different receipt locations. For instance, the processed result to one or more locations may be an indication that the results are ready and/or that the results have been delivered to another receipt location. For instance, the processed results may be sent to a computer and/or to a file server.

A user, which may be the same user or a different user to the user that provided the analysis stage for the sample, may view the processed results. The user may be required to log into a computer to view the processed results.

The processed results, potentially including any hard copies thereof or extracts there from may include an identifier. The processed results may include within it an identifier to link it to one or more of the processing stage, potentially including steps and/or criteria used therein, the identity of the identifier included in the results, the sample analysis kit, cartridge, container for reagents or materials, the sample collection kit, sample collection device, one or more containers in the sample collection kit, sample, person providing the sample or record of information given by or taken from the person providing the sample.

The processed results may provide a report. The report may provide one or more of: a profile for the sample, an indication of a lack of a match with any of the previous results obtained from that or like instruments and/or from other instruments delivering similar information and/or databases storing such results, an indication of a match, potentially together with an indication of the sample with which the match occurs and/or the identity of the person with whom there is a match. The report may provide and/or may further provide one or more of a list of possible matches and/or the likelihood of the match for the one or more of the possible matches.

Where a match is determined or suggested, the report may include information which may be included within the processed results as to the match. This information may relate to the person for whom there is a match and/or a case for which there is a match and/or a crime for which there is a match. The information may include information on the law enforcement authority and/or law enforcement officer in the case with which there is a match. A message and/or other information may be provided to that law enforcement authority and/or law enforcement authority.

Where a match is determined or suggested, the report may include information from one or more other data sources. The one or more other data sources may include record systems or databases which store non-DNA related information. The one or more other data sources may be a law enforcement case recordal database. The DNA related information database may contain in the information for one or more of its records an identifier which allows that record to be linked to a record on one or more other databases, for instance of the law enforcement case recordal type. The information included within the report may indicate the nature of the crime or act associated with the match and/or date thereof and/or location thereof. This information may be part of the record on the DNA related information database and/or the law enforcement case recordal database.

If the results processing stage and/or one or more other stages in the process fail, then this may be indicated to a user or person. The indication may indicate whether the analysis was a total fail, for instance from which no useful information is obtained, and/or a partial fail, for instance from which some useful information was obtained, and/or a success, for instance from which a full set of information was obtained. The reasons for the fail or partial fail may be provided. The reason may be an analytical failure. The reason may be an instrument failure. The reason may be a cartridge failure. The reason may be a detailed processing failure. In the event of a failure, the user can request a further analysis be triggering such a request and/or be triggering a resend of the data for analysis.

In the processed results consideration stage one or more further actions or steps may be triggered. The one or more further actions may be a, potentially computer implemented, consideration of and/or the inspection of one or more other databases and/or record systems, for instance to obtain further information.

In the database or records modification stage one or more further actions or steps may be triggered. The one or more further actions may be a, potentially computer implemented, linking of the results and/or a record associated with the sample to results and/or a record associated with one or more other samples, files or events, such as crimes, or individuals. The linking may be provided by the addition of a link on the database or record system between the two and/or the generation of a further record containing the two records or extracts there from.

In the results based action stage one or more further actions or steps may be triggered. The one or more further actions may be the individual who was the source of the sample being kept present at a law enforcement premises and/or with a law enforcement officer. The person may be kept present, for instance detained or under arrest or rearrested, at a law enforcement premises and/or with a law enforcement officer for an increased period of time, for instance increased with respect to the time if a match and/or a chance of a match had not been indicated.

The process may provide that the sample, particularly when collected from an individual, is processed through to the results and/or report in a given time frame, for instance less than 3 hours. The process may provide that the samples, particularly when collected from an individual, is processed through to the results and/or report whilst the individual is still present, for instance detained or under arrest, at a law enforcement premises and/or with a law enforcement officer.

The process may provide a result or report establishing whether or not the sample matches with a record of another sample of a database and/or could match with a record of another sample of a database, such as The National DNA Database®, within that limit.

A match and/or a chance of a match may result in the individual being still present, for instance detained or under arrest or rearrested, at a law enforcement premises and/or with a law enforcement officer for an increased period of time, for instance increased with respect to the time if a match and/or a chance of a match had not been indicated.

One or more calibration and/or diagnostic and/or control steps may be provided for the instrument and/or loaded item, such as cartridge. One or more calibration and/or diagnostic and/or control steps may be provided for one or more components and/or reagents and/or processing aids of the instrument and/or cartridge.

One or more calibration and/or diagnostic and/or control steps may be provided within one or more verification stages. A verification stage may be provided before one or more other stages, for instance before a sample loading stage and/or cartridge loading stage and/or analysis stage. A verification stage may be provided after one or more other stages, for instance after results stage and/or results transmission stage and/or result processing stage and/or processed results transmission stage and/or processed results consideration stage and/or database or records modification stage and/or results based action stage. A verification stage may be provided between each use of the instrument. A verification stage may be provided between a use of an instrument and the next after a given number of uses and/or before a given number of uses is exceeded. The given number may be 5 or 10 or 20.

A verification stage may be provided in which information is sent to and/or received from another location, preferably a remote location. The another location may provide return information. The return information may be sent to the instrument and/or to one or more further locations, such as a computer.

The information may include information on one or more of: the instrument identity, the user identity, the time of use, the date of use, the sample type analysed, the cartridge identity, one or more processes applied, error reports, the hardware version, the software version

The one or more processes applied may include information on one or more of: the temperatures, temperature profiles, voltages, currents or other operating conditions for one or more or all of the components of the instrument and/or cartridge and/or the sequence of operation thereof.

The return information may include one or more of: details of one or more errors, one or more triggers for actions by the instrument and/or user, one or more warnings to the instrument and/or user, an indication to the instrument and/or user of the need for maintenance of the instrument and/or calibration of the instrument and/or diagnostics for the instrument and/or controls for the instrument and/or a further verification stage. The actions may include determining and/or indicating when maintenance of the instrument is needed and/or preventing use of the instrument because of the information.

The information and/or the return information may be stored, for instance in an archive function.

A calibration may be used to enable the instrument to revalue one or more variables in its operation to the correct state or form. A diagnostics may be used to enable the performance of the various components and/or the sequence of operation of the instrument and/or cartridge to be verified. A control may be provided to enable the response of the instrument to a control sample to be established, for instance to confirm accurate analysis or cause one or more changes to the process.

One or more loadable elements, such as cartridges, may be provided with the loadable element providing one or more calibrations and/or diagnostics and/or controls, for one or more processes and/or components.

A separate type of cartridge may be provided for each type of calibration and/or diagnostics and/or control. A cartridge may be provided which provides more than one calibration and/or diagnostics and/or control. A calibration and/or diagnostics and/or control cartridge may be incapable of being loaded with and/or analysing a sample. A calibration and/or diagnostics and/or control cartridge may be sealed cartridge.

A calibration cartridge may be pre-prepared with one or more samples and/or reagents and/or processing aids and/or components and/or items which operate in the cartridge in a manner which simulates the process in its intended operation. The calibration cartridge may provide one or more known outputs to the instrument. The known output may be one or more temperatures. The items may include one or more heat sources of a known temperature, for instance to provide known temperatures to sensors on the instrument. The temperature detected can then be compared with the temperature which should have been detected. The known outputs may be one or more sizes or signals indicative of size. The components may include one or more known size components or mixtures of sizes. These may be used to provide measureable components by a size analysis step. The sizes detected can then be compared with the sizes which should have been detected. The calibration cartridge may provide one or more known outputs to a user, for instance an indication that one or more of the valves within a cartridge has been triggered, for instance by a colour change.

A diagnostics cartridge may be pre-prepared with one or more samples and/or reagents and/or processing aids and/or components and/or items which operate in the cartridge in a manner which simulates the process in its intended operation. The diagnostic cartridge may detect one or more inputs from the instrument to the cartridge. The inputs may be one or more temperatures generated in the cartridge at one or more locations, one or more sequences of temperature generated in the cartridge at one or more locations, one or more threshold temperatures or above generated in the cartridge at one or more locations. The inputs may be one or more currents and/or voltages and/or magnetic fields applied to one or more components and/or locations of the cartridge. The diagnostic cartridge may detect the actual position of the diagnostic cartridge within the instrument relative to the intended position of a cartridge or the diagnostic cartridge within the instrument. The diagnostic cartridge may detect one or more pressures applied to the diagnostic cartridge by the instrument or components thereof.

A control cartridge may be pre-prepared with one or more samples and/or reagents and/or processing aids and/or components and/or items which operate in the cartridge in a manner which simulates the process in its intended operation, and particularly provide known results. The results may be known in terms of one or more of the level of detectable component, such as DNA, within the control sample, the characteristics, such as sizes or identities, of components within the control sample or the characteristics, such as sizes or identities of a size standard.

The calibration and/or diagnostics and/or control cartridges may be provided pre-prepared to the user. Preferably no physical interaction between the user and the inside of the cartridge is possible.

The one or more verification stages and/or one or more calibration and/or diagnostic and/or control steps may include communication with the same or different locations and/or remote locations and/or another locations as are used in one or more other stages. The one or more locations and/or remote locations and/or another locations used in the one or more verification stages and/or one or more calibration and/or diagnostic and/or control steps may be different to the one or more locations and/or remote locations and/or another locations used in the results transmission stage and/or result processing stage and/or processed results transmission stage and/or processed results consideration stage and/or database or records modification stage and/or results based action stage. The one or more locations and/or remote locations and/or another locations which archive the information and/or return information may be different to the one or more locations and/or remote locations and/or another locations which provide the one or more verification stages and/or one or more calibration and/or diagnostic and/or control steps.

Various embodiments of the present invention will now be described, by way of example only, and with reference to the accompanying drawings in which:

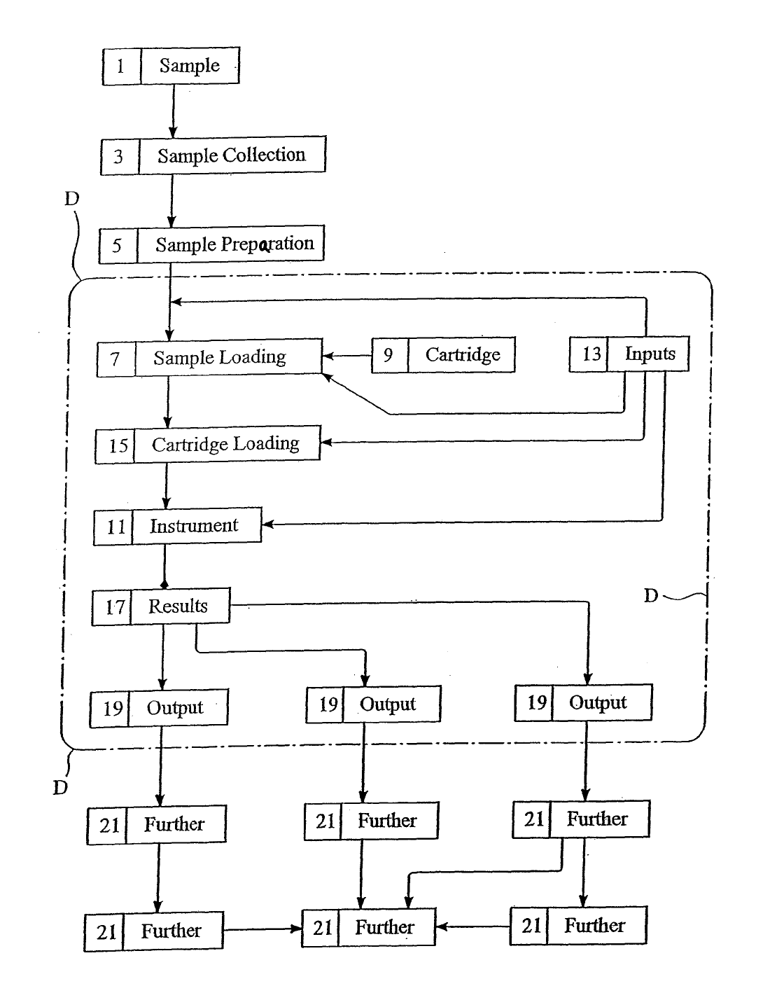

FIG. 1 is a schematic illustration of the stages of the present invention, in the context of the overall process in which the invention is deployed.

### BACKGROUND

In a variety of cases it is desirable to be able to analyse a biological sample to obtain information there from. Such cases include medical diagnostics, for instance to look for disease markers, and forensics, for instance to establish a DNA profile. In other uses biological and/or non-biological samples are considered to obtain information thereon. Such cases include border control, homeland security, radiological detection and monitoring and the like.

At present, such analyses are conducted by highly trained scientists in a laboratory environment. This means that a significant amount of effort and experience goes into the handling of the samples, the use of the analysis equipment and the formulation of the conclusions reached. However, the need to convey the sample to a laboratory environment and then receive the results back from there introduces a potential time delay between possessing the sample and possessing the results thereon. The need to use a laboratory environment and highly trained scientists potentially adds to the time required, as the supply of such people and resources is limited. The need to use a laboratory environment and highly trained scientists potentially adds to the cost as there are capital and running costs associated with such facilities and the scientists.

If less laboratory style environments are to be used for the analysis or the staff used are less specialised, then there is the potential for problems with the analysis, unless a proper and reliable system is provided.

The present invention has amongst its potential aims to enable analysis of samples at a greater variety of locations and/or non-laboratory type locations. The present invention has amongst its potential aims to enable analysis by personnel having a lower level of training and/or experience. The present invention has amongst its potential aims to enable lower cost and/or faster analysis of samples. The present invention has amongst its potential aims to enable a greater number of samples to be analysed, on a commercial basis, than using present technology.

Crucial to the ability to operate an such analysis system reliably and accurately is the information which is received by the analysis system and the information which is outputted by the analysis system.

The input and output information form and content is also highly important to rendering the analysis system practical in the situations in which it is intended to function.

It is also most important, particularly where the analysis may form part of the information used in a legal investigation or evidence used in legal proceedings, that the analysis is verifiable and capable of withstanding valid scrutiny.

Many of the concepts and issues to be addressed by the invention are best understood by way of the following example. It should be noted, however, that this example is by its very nature detailed and exhaustive, and that benefits from the present invention arise even when only small sections of the example are implemented in other embodiments of the present invention.

### Process Overview

In the context of the example, FIG. 1 shows a schematic of the overall process into which the present inventions fit. This overall process includes a sample 1 which is gathered in a sample collection stage 3. This is followed by a sample preparation stage 5 and sample loading stage 7. In the sample loading stage 7, a clean cartridge 9 is loaded with the sample 1. The instrument 11 also receives various inputs 13 at the sample loading stage 7 and/or in the cartridge loading stage 15 which follows. The loaded cartridge arising is placed in the analysis instrument 11. It is of course possible, and in some instances preferably, to load the cartridge into the instrument 11 using cartridge loading stage 15 and then introduce the sample 1 to the clean cartridge 9 using a cartridge loading stage 15.

The next stage is the results stage 17 and this follows the performance of the analysis by the instrument 11. This is followed by one or more output stages, 19 and potential further stages 21 which integrate the analysis into the criminal justice system of that jurisdiction. A wide range of possible links between the various output stages 19 and further stages 21 may be possible, with some being linked to just one stage and others be the result of multiple such stages and/or combinations thereof.

### Sample Collection, Transportation and Preparation

A wide variety of sample collection approaches are possible and can be used to feed sample to the process. The collection of blood, buccal swab, bodily fluid and whole cells as the sample is possible.

For instance, it is possible to collect the sample using a buccal swab. The sample free end of a swab is exposed and then used to scrap the inside of the cheek of the person. The swab is then placed in a secure container to prevent contamination during transportation and storage. A wide variety of such swabs can be used, including planar swabs, cotton wool swabs, swab brushes and the like.

Once at the sample preparation stage the sample is released from the swab.

Collection approaches in which the sample is applied to the exposed surface of a treated matrix are also possible. The matrix generally contains chemicals to promote lysis of the cells within the sample and so release the DNA of interest. The matrix is fibrous in nature and the fibres serve to capture the released DNA within the matrix. The captured DNA is thus retained for transportation and/or storage. Room temperature transportation and storage is possible.

When it is necessary to release the DNA from the matrix, the appropriate liquid chemicals are applied. This is normally achieved by taking the matrix with the DNA in it and detaching a small part of the matrix for elution of the DNA. A punch device is commonly used for this purpose. The small part of the matrix is washed with a purification reagent and then rinsed with an eluent. Such a matrix based system is available from Whatman Inc, Newton, Mass. 02459-3304, USA as the FTA® card nucleic acid collection approach.

In the FTA Elute version of the system, a modified chemistry is used in the matrix so as to only require water and heat to give the eluted DNA. The small piece of the matrix is punched into a tube, contacted with water, centrifuged to allow excess water to be removed, contacted with further water at 95° C. for 30 minutes and then centrifuged to give the elute DNA sample.

In the EasiCollect® device, the matrix is provided in a rigid casing with an aperture there in which leads to the matrix. The surface of the matrix is protected by a protective layer. Extending from the casing is a stem with a swab at the end. The swab is used to collect the sample. The protective layer is removed from the matrix and the stem is bent at a predetermined location to bring the swab, and hence sample, into contact with the matrix. The matrix acts in the manner described above to lyse and store the sample.

Other collection approaches include the GenePlate® collection system available from GeneVault of 6190 Corte Del Cedro, Carlsbad, Calif. 92011, USA and the complimentary elution chemistry offered as the GeneSolve® kit. This kit is also described as applicable to eluting from FTA matrices and Guthrie card matrices. The small piece of the matrix is punched into a tube and then a mixture of a lycophilized reagent and protease is added. An incubator/shaker is used to agitate tube at 65° C. for an hour. This is then centrifuged and excess fluid is removed. A further reagent is then added before further centrifuging and prepared sample removal from the tube. A purification stage may then be applied using Qiagen's QIAmp DNA Blood Mini kit. The DNA present may be quantified before further processing.

In a further preferred collection approach, a plastic holder is employed which includes a handle for the operator and label for writing on. A slideably cover provided on the holder can be drawn back to expose the cotton paper sample collection area. That area is brought into contact with the sample, for instance to take a buccal sample. The cover is then slid back into position to protect the sample against contamination. The paper acts in a similar manner to that outlined above and can be transported and stored at room temperature.

To obtain the DNA for analysis, the paper is exposed at a small piece of the matrix detached, for instance by punching. The small piece of the matrix is then contacted with a preparation solution and incubated (for instance 70° C. for 20 minutes) to place the DNA in a state suitable for PCR.

A system of this type is detailed in WO02/096480. A system of this type is available from The Bode Technology Group Inc, 10430 Furnace Road, Suite 107, Lorton, Va. 22079, USA and includes the Bucall DNA Collector, PunchPrep Solution reagents and Promega's PowerPlex® 16 HS reaction mix.

All of the above collection approaches and others can be used to obtain and deliver samples to the process.

In the case of samples taken from known persons, it is envisaged that the instrument for analysis will be in physically proximity with that person. Thus the sample may only have to travel a few 10's of meters before analysis and/or may have a relatively short residence time between collection and analysis, for instance under an hour. Such samples will be common in so called “reference sample” cases.

In cases of samples taken from crime scenes or otherwise of unknown origin, the collection approaches described above provide a mechanism for the collection, storage and transportation of the sample to an analysis step. Such samples are commonly referred to as “casework samples”.

The following description of the operation of the instrument 11, in a generally sequential manner, provides full details of the operation.

### User Login and Record

Whilst the successful use of the instrument to analyse a sample does not need the level of training and scientific qualification necessary to operate present laboratory based technology, the intention is that access to the instrument to operate it will still be controlled. To achieve this, the instrument is provided with a log on facility which will only allow access to use the instrument, if the log on is completed successfully. This ensures that the instrument will only be operable by staff who are approved to do so and/or trained to do so.

The log on facility may be password based, pin code based or key based, but in the present form makes use of a biometric characteristic, such as a fingerprint or iris pattern. The biometric source of the user is presented to a reader provided as part of the instrument 11. The reader obtains the necessary characteristics from the biometric source. The instrument 11 is provided with a processor to establish a match (allowing the log on to progress) or non-match (ending the log on or inviting a fresh presentation of the biometric source). The processor may determine the match or non-match using information stored on the instrument and/or information stored at a remote site, for instance a regulatory body or independent body.

A successful log on may be required before the user can open a lid or cover on the instrument or otherwise gain access to the location the sample and/or the cartridge are introduced to. This restriction on the operation may be extended to requiring other information to be entered, for instance relating to the user and/or sample collection kit and/or sample analysis kit.

Once a person has successfully logged in, they can access a further log on procedure to access administrator rights for the instrument. If successful at that log on, the person is able to add and delete authorised users from the system and set up the log on's for those users. The instrument keeps a record of alterations, additions and deletions made, and then provides those to the remote site.

The use of the log on facility results in a variety of data elements being stored. These include the identity of the person logging on to the instrument and the time and date of the log on. This information is transmitted to the remote site and is used in relation to functions described in more detail elsewhere. The act of logging on also causes the instrument to include in the packet of information sent, the identity of the instrument and the location of the instrument.

Even where the user log on is authorised, the ability to use the instrument is subject to other conditions being met. The data packet dispatched to the remote location may be considered against a variety of considerations, with a fail in respect of any one or more of those resulting in further operation of the instrument being inhibited. The considerations may include the user who has logged on, whether they are still authorised to use the instrument, whether their training is up to date and the like. The considerations may relate to the instrument, for instance whether the instrument is functioning correctly, whether recalibration of the instrument is required, whether maintenance of the instrument is required or whether the instrument performed incorrectly in a previous operation.

### Sample Collection Kit

It is important that the sample 1 is linked throughout its consideration to the elements with which it interacts, This is important to ensure that the processing can be audited and to minimise the risk of samples and elements from different cases being mixed up with one another.

To this end, a sample collection kit is used to assist in providing a record of the link between the sample 1 in question and the sample preparation step and/or components in question.

The sample collection kit is provided within packaging and the packaging is provided with a barcode which acts as the primary identity record for that packaging and the kit contents. The sample collection kit provided within the packaging includes a sample collection device, such as a buccal swab, and a sample preparation container, such as a container provided with cell lysis reagents. Both of these items in the sample collection kit are provided with the a barcode to enable their identity to be recorded and to provide a linking identity record between the items in the sample collection kit.

In a preferred form, both items have the same barcode to provide a link between them even before their identity is recorded. The barcode may also be present on the packaging.

When the process starts, the barcode on the packaging may be scanned using a reader. This may be a portable reader or one provided at the sample collection location. For instance, in a police station the reader may be provided at the location where samples are collected from people. The sample collection device barcode and/or sample preparation step component may also be scanned. The barcode or identifier on one or more other components may also be noted at this time, for instance an identifier provided on a sample collection record which is used to link the sample to the person who provided it. A sample collection record may include the person's identity, details of how they confirmed their identity (drivers licence, passport or the like), the location the sample was collected at, time, date and other identifier for the person, for instance a fingerprint or photograph. Information on the alleged offense, for instance in a code form, date of birth and other personal information may also be recorded. In this way, the sample is linked to the paper or computer records for the person and/or the offence in question. The reader results may be stored on a computer database and/or software for linking the readings and meanings thereof collected, together with various other information.

Thus, there is a record of the packaging, sample collection device, sample preparation components, the person providing the sample and other records/files for that person and/or offence as the sample processing starts.

Where a common barcode or common element within it is provided for the different items, then that the barcode is that of the packaging may be indicated by an additional element of the barcode associated with the packaging, alongside the element linking the elements of the sample collection kit.

When the reading of the packaging barcode is made, it may be considered against stored data to ensure that the package is appropriate for use. This is achieved by the instrument communicating with a remote location and receiving information which allows the consideration and/or provides the result of the consideration. The consideration may establish that the sample collection kit is appropriate or inappropriate for the task intended or may establish that the date by which the sample collection kit should have been used has past. A similar result would arise if the consideration revealed that the sample packaging was shown to be from a batch having quality assurance problem, at the time of manufacture or at a later date. This would allow for product recalls to prevent any problematic use immediately.

The result of the comparison may be to provide a warning to the operator and/or to prevent operation of further steps in the process until an alternative packaging has been selected, considered and approved.

To provide complete monitoring of the sample collection process, a similar validation process may be applied to the sample collection device (such as a buccal swab), one or more sample preparation reagents (such as cell lysis reagents).

Following approval, the sample collection stage may be completed so as to prepare for the sample preparation step.

Whilst the invention can be deployed based upon the use of a barcode to provide the identifying link, other forms of identifier may also or alternatively be used, such as a Bluetooth device, a radio frequency device or the like.

The items within the sample collection kit are treated to ensure that they are free of nucleic acids and/or human DNA and/to ensure they are sterile. Ethylene oxide based treatments may be used.

### Sample Preparation and Loading

In general, the sample preparation step will occur at or in transit to the location of the instrument.

The sample preparation step may involve the sample collection device or a part thereof being introduced to a container. The container may provide one or more of the reagents and/or sample preparation aids needed to render the sample to a form suitable for loading to the cartridge.

Various container designs are possible for this purpose.

Connection of the sample loading device, such as a container, directly to the cartridge is beneficial. Contamination free, reliable and complete sample transfer is thus provided.

### Sample Analysis Kit

The user is now ready to proceed with the analysis of a sample. It is important that the sample 1 is provided to the cartridge 9 in a manner which provides a record of the link between the sample 1 in question and the cartridge 9 in question for the reasons given above.

In this respect, it is desirable for the cartridge 9 to be provided as a part of a sample analysis kit. The sample analysis kit is preferably separate from, but may be supplied with the sample collection kit described above, for instance within an overall kit provided within sealed packaging. The sealed packaging is a light proof, shrink wrapped unit, prepared in a protected atmosphere and hence designed to protect the clean components fully prior to use. The packaging may also be tamper evident to provide further security. The storage conditions and other relevant information may be printed on the packaging.

The separate provision of the sample collection kit from the sample analysis kit allows a wide variety of sample collection kits to be provided. This is useful in the case of samples from crime scenes and the like, casework samples, or other situations where the nature of the sample necessitates different sample collection approaches.

The packaging is provided with a barcode which acts as the primary identity record for that packaging and its contents. The sample analysis kit provided within the packaging includes the cartridge 9 and one or more cartridge reagents which need to be added to the cartridge for the analysis to be performed (if not already provided in the cartridge). In preferred embodiments, the cartridge reagents will be pre-loaded in the cartridge.

The barcode may be the same, or more usually different, from that used on the sample collection kit items and its packaging. This allows a range of different sample collection kits, aimed at different sample types which need to be collected, to be used in the overall process.

Before the analysis starts and preferably before the sample loading starts, the barcode on the packaging is scanned by the reader on the instrument. This may be the same or a different reader to that used above for the sample collection kit. The reader may be linked to the same database and/or software so as to enable the complete set of sample to item links to be made and/or a complete record of the process relative to the sample to be kept.

Thus there is a record of the packaging, cartridge and other items used in this step, which is linked to the person providing the sample and other records/files for that person and/or offence and to the sample collection kit and items as the sample analysis step starts.

Where a common barcode or common element within it is provided for the different items, then that the barcode is that of the packaging may be indicated by an additional element of the barcode associated with the packaging, alongside the element linking the elements of the sample collection kit.

When the reading of the packaging barcode is made it may be considered against stored data to ensure that the package is appropriate for use. This is achieved by the instrument communicating with a remote location and receiving information which allows the consideration and/or provides the result of the consideration. The consideration may establish that the sample analysis kit is appropriate or inappropriate for the task intended or may establish that the date by which the sample analysis kit should have been used has past. A similar result would arise if the consideration revealed that the sample packaging was shown to be from a batch having quality assurance problem, at the time of manufacture or at a later date. This would allow for product recalls to prevent any problematic use immediately.

The result of the comparison may be to prevent operation of further steps in the analysis until an alternative packaging has been selected, considered and approved. For instance, physical access to the route through which the sample is introduced to the cartridge 9 may be prevented. The instrument 11 may provide a physical barrier or obstruction to the sample in its sample preparation container being connected to the cartridge and/or introduced to the instrument.

To provide complete monitoring of the sample analysis process, a similar validation process may be applied to the one or more cartridge reagents which need to be added to the cartridge for the analysis to be performed.

Following approval, the sample collection and sample preparation stages have been completed and the sample is ready for loading into the cartridge 9. This may occur before, but preferably occurs after the cartridge 9 is loaded into the instrument 11.

When the cartridge 9 is loaded into the instrument 11, the barcode may be inputted to the instrument 11 using a barcode reader. This enables the instrument 11 to form the link between the cartridge 9 and the results packet for that cartridge, when the results arise. This may be achieved by a reader or identify detector provided in the instrument. In this way no confusion between the scanned cartridge and the actually loaded cartridge can arise.

Whilst the invention can be deployed based upon the use of a barcode to provide the identifying link, other forms of identifier may also or alternatively be used, such as a

Bluetooth device, a radio frequency device or the like.

The presence of the logged identifier on the various items in the various kits also allows those items to be archived and successfully recalled at a later date. For instance, there may be a need to retest the sample and/or inspect the cartridge or some detail of it.

The reader and/or the instrument may allow for the manual entry of the identifier where there is a problem with the operation of the reader and/or the identifier/barcode is impaired in some way.

The items within the sample analysis kit are treated to ensure that they are free of nucleic acids and/or human DNA and/to ensure they are sterile. Ethylene oxide based treatments may be used.

Reagent Storage and/or Quality Control

In general, it is preferred that the sample preparation step, for instance provided by a container, be pre-provided with all of the reagents and components it needs for the performance of the step. In this way, the simplicity of the overall system is maintained and the reagents and the like can be pre-provided to high standards.

The same is also preferred for the cartridge and its reagents, aids and components. The gas filled parts of the cartridge, such as various chambers and/or channels may be filled with an inert atmosphere, such as nitrogen.

### Other Physical Inputs

To keep the operation of the process as simple as possible, the cartridge and the sample preparation step, for instance in container form, preferably provide all of the reagents, components and aids needed to perform the process in the cartridge.

In more limited cases, it may be necessary to provide one or more other physical inputs, such as the matrix in which a size based separation is provided. This may for instance, be the polymer within which a capillary electrophoresis step is provided. Such an approach may be taken where a reagent or the like is not suitable for long term storage in the cartridge. In such a case, the component could be delivered in a container and that could then be attached to the cartridge to provide the component to the necessary part of the cartridge.

### Instrument Indications to User

With the cartridge in the instrument 11, the instrument is ready to receive the sample from the sample preparation step. As mentioned above, the cartridge 9 may be subject to checks before this is allowed to happen. In cases where the stability of the cartridge is an issue and/or there are issues with one or more components in the cartridge, further checks may be made to ensure that the time period between the cartridge being placed in the machine and the sample being presented is not to long. This may be between the sample analysis packaging being opened, where that point in time is set by scanning the sample analysis packaging because the opening of the packaging prevents any subsequent reading of the barcode, or between the cartridge being loaded to the instrument and the present point in time. Where the time passed exceeds a value, the instrument may prevent operation of further steps in the analysis until an alternative packaging has been selected, considered and approved in good time. For instance, physical access to the route through which the sample is introduced to the cartridge 9 may be prevented. The instrument 11 may provide a physical barrier or obstruction to the sample in its sample preparation container being connected to the cartridge and/or introduced to the instrument. Such an approach would prevent a cartridge 9 being loaded to the instrument 11 well before it was needed, with potentially detrimental results on the accuracy and/or reliability of the subsequent analysis.

Similar checks may be applied with respect to the length of time the sample has spent in the sample collection step and/or sample preparation step and/or a container.

Once successfully loaded, the instrument 11 could provide an indication to the user than the instrument is ready to start analysis, but it is preferred that the instrument 11 automatically starts so as to prevent the sample being left in the cartridge for a significant period before analysis and/or to prevent the cartridge being left in the instrument for a significant period before analysis. This can be important because the temperature within the instrument may be higher than ambient and thus reduce acceptable storage times for the sample and/or cartridge.

After the user starts the analysis, the instrument 11 may automatically log off the user from using the interface. In this way, the instrument 11 is secured during the analysis against interference or use by another user who might otherwise appear to the instrument to be the logged on user. This is important, as the analysis time frame is such that the instrument is unlikely to be supervised by the logged on user continuously throughout that time.

During the analysis, the instrument provides an extent of progress indication to the user, or any other interested party. The indication is available to any party, without a requirement for a successful log on to the instrument. The indication may be a level of progress indication, for instance a percentage, or a number of stages completed out of a given number in total or the like.

During the analysis, the user and/or any other person may be prevented from opening a lid or cover on the instrument or otherwise gaining access to the location the sample and/or the cartridge are present at. A similar restriction may be placed on the user and/or any other person amending or editing the information provided to the instrument by a user.

The instrument 11 provides an indication of an unsuccessful analysis, if at any time during the analysis the instrument and/or the remote location reaches such a conclusion based upon the output from the analysis. This may be the actual results output and/or a monitoring data output. If an unsuccessful analysis is indicated, the instrument provides the option of conducting a fresh analysis of the sample. The fresh analysis requires a fresh log on, sample collection kit, sample analysis kit, including cartridge and the like to be employed.

To minimise the chances of an unsuccessful analysis, the instrument conducts a series of pre-analysis checks and diagnostics to ensure it is working correctly. If a failure does occur, then a log of that is generated, preferably including details of the stage the analysis had reached, the nature of the failure and a reason as far as that can be identified. The log may be interpreted by a local user and/or the remote location so as to enable the quick return of the instrument to correct operation. This may include the triggering of maintenance work or the like.

The instrument 11 provides an indication of a successful analysis, if the end of the analysis the instrument and/or remote location reach such a conclusion based upon the output from the analysis.

In the event that the progress of the analysis is interrupted, the process may allow the process to be restarted at the same point and/or a previous point in the process. The results file for the analysis may include a record of such an interruption and the actions arising. Such an interruption might occur due to an interruption in the power supply to the instrument.

The user may have the option to stop an analysis part way through. The analysis may be stopped and/or restarted at that point in the analysis process when the stop request is made. The analysis may be stopped and/or restarted at the next allowable point in the analysis process after the stop request is made. The next allowable point may be after the completion of one operation within the cartridge and/or before the start of the next operation within the cartridge. The results file for the analysis may include a record of such an interruption and the actions arising. Such an interruption might occur due to the need to process a different sample more urgently. A time limit may apply to the time between stopping the process for a sample and/or cartridge and restarting the process for that sample and/or cartridge.

### Instrument Output

Upon completion of the analysis, the user may be offered the option of triggering the dispatch of the analysis results to a remote location. More preferably the dispatch of the analysis results occurs automatically so as to minimise any delay between completion of the analysis and the start of the interpretation step.

The content of the dispatch may include the raw results data file generated by the instrument, such as by a capillary electrophoresis analysis, and an identifier for the dispatched results. In this way, the dispatch results are also tied to the various items used in the process and to the original sample.

The intention is for the detailed processing of the results of the analysis to be conducted at a remote location. The remote location could be a central facility which handles the processing for a number of instruments, potentially for a number of different instrument owners and/or users. The dispatch of the analysis results could be more local, for instance within the same organisation and/or building as the instrument and/or over a LAN or the like. The analysis could be conducted on the instrument and/or on a computer connected to it, for instance directly thereto, by the provision of appropriate software for the interpretation on the instrument and/or computer.

Depending upon the outcome of the analysis result dispatch, the instrument receives and provides to the user an indication of successful dispatch and receipt or unsuccessful dispatch or receipt. The dispatch may be to one or more different remote locations, for instance with different data sets being sent to different remote locations. If the dispatch is unsuccessful and/or receipt is unsuccessful, the user s provided with the option of retriggering the dispatch.

If and when a successful dispatch and receipt is obtained, the instrument may provides a hard copy receipt to the user by means of a printer. The receipt may include within it the identifier to link it to the process for that case.

The indication received back by the instrument and/or the hard copy are provided with an indication of the expected time and/or date upon which the user can expect the analysis results back from the remote location analysing the output from the instrument.

### Interpretation Report

The results sent back may be provided to a variety of locations and/or in a variety of forms. These can be tailored to reflect the location and/or person receiving the results and/or the type of detailed processing request and/or applied. For instance, it is possible for an automated message, e-mail, SMS or the like to be sent to a person's telecommunications device and/or computer. This may alert the person that the results are available to them. It is for instance, possible for the results to be sent to a location from which they can be accessed by one or more people, for instance a server or database. The results may be sent to a person's computer. In some cases, the results may be sent to the instrument.

To view or otherwise access the results sent back from the remote location, the user and/or another person may be required to log on to the instrument again and/or on to the applicable computer or other device. An indication that the results have been received back is provided without logging on, but the results themselves cannot be viewed in that format.

Once the user has logged on, the results report can be viewed and/or printed as a hard copy. Again any hard copy may include on it the identifier to link it to the process for that case.

The content and/or presentation of the report can be tailored to the needs of the analysis and final outputs there from. Thus the report can be as simple as a profile for the sample and/or an indication of a lack of a match with any of the previous results obtained from that or like instruments and/or from other instruments delivering similar information and/or databases storing such results. The report can be an indication of a match, potentially together with an indication of the sample with which the match occurs and/or the identity of the person with whom there is a match. In a more detailed form, the report may include a list of possible matches and/or the likelihood of the match for the one or more of the possible matches. Where a match is determined or suggested, the report may include information which may be included within the results as to the match. This information may relate to the person for whom there is a match and/or a case for which there is a match and/or a crime for which there is a match. The information may include information on the law enforcement authority and/or law enforcement officer in the case with which there is a match. A message and/or other information may be provided to that law enforcement authority and/or law enforcement authority.

Where a match is determined or suggested, the report may include information from one or more other data sources. The one or more other data sources may include record systems or databases which store non-DNA related information. The one or more other data sources may be a law enforcement case recordal database. The DNA related information database may contain in the information for one or more of its records an identifier which allows that record to be linked to a record on one or more other databases, for instance of the law enforcement case recordal type. The information included within the report may indicate the nature of the crime or act associated with the match and/or date thereof and/or location thereof. This information may be part of the record on the DNA related information database and/or the law enforcement case recordal database.

In some instances, the analysis may fail for some reason. This is indicated to the user. The indication may indicate whether the analysis was a total fail, for instance from which no useful information is obtained and/or a partial fail, for instance from which some useful information was obtained and/or a success, for instance from which a full set of information was obtained. The reasons for the fail or partial fail may be provided. The reason may be an analytical failure. The reason may be an instrument failure. The reason may be a cartridge failure. The reason may be a detailed processing failure. In the event of a failure, the user can request a further analysis be triggering such a request and/or be triggering a resend of the data for analysis.

The connection between the instrument and the one or more remote locations may be provided by any telecommunications option, including Internet, mobile telecommunications, such as so called third generation mobile telephone technology or satellite based communication technology.

On occasions, the instrument may not be able to communicate with one or more of the remote locations when it wishes to. In those instances, one or more of the steps mentioned may be allowed, particularly the conduct of an analysis. In that instance, the analysis results are stored in the instrument and stacked ready for dispatch, once the connection with the remote location has been re-established.

### Actions Based on Interpretation

As a result of the results and/or report one or more further actions may be triggered.

The further action may be the inspection of one or more other databases and/or record systems for further information. The further action may be the linking of the record associated with the sample to a record associated with one or more other samples, files or events, such as crimes, or individuals. The linking may be provided by the addition of a link on the database or record system between the two and/or the generation of a further file or record containing the two files or records or extracts there from.

The further action may be the individual being kept present at a law enforcement premises and/or with a law enforcement officer.

The process may provide that the samples, particularly when collected from an individual, is processed through to the results and/or report in a given time frame, for instance less than 3 hours. The process may provide that the samples, particularly when collected from an individual, is processed through to the results and/or report whilst the individual is still present, for instance detained or under arrest, at a law enforcement premises and/or with a law enforcement officer. The process may provide a result or report establishing whether or not the sample matches with a record of another sample of a database and/or could match with a record of another sample of a database, such as The National DNA Database®, within that limit. A match and/or a chance of a match may result in the individual being still present, for instance detained or under arrest or rearrested, at a law enforcement premises and/or with a law enforcement officer for an increased period of time, for instance increased with respect to the time if a match and/or a chance of a match had not been indicated.

### System Diagnostics and Upgrades

As well as the normally operation of the instrument described above, the instrument is capable of a wide variety beneficial other data exchanges and considerations, particularly with the one or more remote locations.

In the above context, the instrument may provide data relating to the underlying operation of the instrument. This provides a log of the instruments operation which is available for consideration and/or to support the valid operation of the instrument in the context of a given analysis. The log includes details of the timing of the analysis and its component parts, temperatures, temperature profiles, voltages, currents and other operating conditions used. The sequence of operation of the various components is also recorded, to show proper operation of the cartridge. The log also includes details of the hardware and software versions used and other information to enable the analysis to be fully reconsidered and/or replicated.

As a result of this log there is significant information on the operation of the instrument for each process run. This can be beneficial to diagnosis of a fault in a subsequent run and/or provide prior warning of a deterioration or change in a part of the instrument or its operation.

Before a process is started, it is desirable that the instrument provides a pre-process diagnostic check to ensure all components and steps are available for operation and opening as intended.

As mentioned previously, one or more remote locations can be used to monitor the instrument for its maintenance position being up to date, its software being up to date and the validity of the user logged on to use the instrument.

In another context, the instrument may provide data useful to the continued successful operation of the instrument and/or continued availability of the instrument for use.

Thus the data can be used to indicate to the operator the times at which a calibration run needs to be performed on the instrument and/or a diagnostics run and/or control run. The calibration run enables the instrument to revalue one or more variables in its operation to the correct state or form. The diagnostics run enables the performance of the various components and the sequence of operation of the device to be verified. A control run enables the response of the instrument to a control sample to be established and thus confirm accurate analysis.

The calibration and/or diagnostics and/or control runs may make use of specific cartridges built for one or more or all of those purposes. These cartridges may be distinctly provided when compared with normal cartridges.

In the case of a calibration cartridge, this may be provided with one or more samples and/or reagents and/or processing aids and/or components and/or items which operate in the cartridge in a manner which simulates the process in its intended operation. The calibration cartridge may provide one or more known outputs to the instrument. The known output may be one or more temperatures. The items may include one or more heat sources of a known temperature, for instance to provide known temperatures to sensors on the instrument. The temperature detected can then be compared with the temperature which should have been detected. The known outputs may be one or more sizes or signals indicative of size. The components may include one or more known size components or mixtures of sizes. These may be used to provide measureable components by a size analysis step. The sizes detected can then be compared with the sizes which should have been detected. The calibration cartridge may provide one or more known outputs to a user, for instance an indication that one or more of the valves within a cartridge has been triggered, for instance by a colour change.

In the case of a diagnostics cartridge, this may be provided with one or more samples and/or reagents and/or processing aids and/or components and/or items which operate in the cartridge in a manner which simulates the process in its intended operation. The diagnostic cartridge may detect one or more inputs from the instrument to the cartridge. The inputs may be one or more temperatures generated in the cartridge at one or more locations, one or more sequences of temperature generated in the cartridge at one or more locations, one or more threshold temperatures or above generated in the cartridge at one or more locations. The inputs may be one or more currents and/or voltages and/or magnetic fields applied to one or more components and/or locations of the cartridge. The diagnostic cartridge may detect the actual position of the diagnostic cartridge within the instrument relative to the intended position of a cartridge or the diagnostic cartridge within the instrument. The diagnostic cartridge may detect one or more pressures applied to the diagnostic cartridge by the instrument or components thereof.

In the case of a control cartridge, this may be provided with one or more samples and/or reagents and/or processing aids and/or components and/or items which operate in the cartridge in a manner which simulates the process in its intended operation, and particularly provide known results. The results may be known in terms of one or more of the level of detectable component, such as DNA, within the control sample, the characteristics, such as sizes or identities, of components within the control sample or the characteristics, such as sizes or identities of a size standard.

The calibration and/or diagnostics and/or control cartridges may be provided pre-prepared to the user. Preferably no physical interaction between the user and the inside of the cartridge is possible.

The data can be used to establish when maintenance of the instrument is need, ideally to pre-empt faults developing with the instrument. The data can be used to lock down and prevent use of the instrument, if a serious or potentially serious fault is detected or anticipated.

To be able to verify one or more aspects of the analysis or results there from, an archive function may be provided. This may archive the sample as collected and/or sample as prepared and/or sample as analysed. A repeat of the analysis may thus be facilitated at a later date. The application of the barcode to these components too enables them to be clearly linked to the other elements.

As mentioned above, the instrument can be in communication with one or more remote locations and/or receive data there from and/or send data thereto. The different locations may be used for different purposes. In particular, the remote location which provides for the analysis of the results and the return of the processed results to the instrument may be different to the remote location which provides the performance monitoring, fault diagnosis, calibration or control considerations. A remote location may be provided which receives and stores the log records of the conditions etc under which the instrument operated during the analysis. One or more of the remote locations may be operated or controlled by a body independent of the persons or organisations performing analyses; in this way independent verification can be provided.

As can be seen, the issues addressed by the present invention are applicable for a wide range of legal systems, where the manner in which the sample is collected and/or the manner in which the results are used varies greatly from legal system to system. This makes the present invention useful in a very wide range of jurisdictions, including specific countries and/or states, counties or other divisions therein.

1. A method for collecting a sample and/or analysing a sample, the method comprising:
a. providing a kit, the kit comprising: packaging for one or more devices or containers; and one or more devices and/or one or more containers;
and wherein an identifier is provided on one or more of the devices and/or containers and/or packaging;
b. using the one or more devices or containers to collect a sample and/or using one or more of the devices and/or containers to analyse a sample;
c. recording the identity of the identifier for one or more of the identifiers provided;
d. linking the identity of the identifier for one or more of those identifiers to one or more of the identities for one or more of the other identifiers.

2. A method according to claim 1 wherein the identity of the identifier is recorded and linked for two or more of: the record of the person providing the sample, the sample collection device, the sample preparation container, the cartridge for analysing the sample, a record of the results of the analysis, a record of the processed results or a record arising from the modification stage.

3. A method according to claim 1 wherein the sample collection stage use a sample collection device and the sample collection device is placed in a container, and one or more of the following are provided:
the identity of the identifier for the sample collection kit packaging is recorded before the packaging is opened;
the identity of the identifier for the sample collection device is recorded before the device is used to collect a sample and/or after;
the identity of the identifier for the container provided in the sample collection kit is recorded before the sample is collected and/or before the sample collection device is placed in the container and/or after.

4. A method according to claim 3 wherein the identity of the identifier recorded is use to link the sample collection kit and/or sample collection device and/or container to the sample and/or to the person providing the sample and/or to a record of information given by or taken from the person providing the sample.

5. The method of claim 1, wherein the item or items needed for the sample loading stage and/or cartridge loading stage and/or sample analysis stage are provided in a sample analysis kit, one or more of the following being provided for the sample analysis kit:
the sample analysis kit may consist of a cartridge in packaging;
the sample analysis kit packaging and/or one or more items therein are provided with an identifier and the identity of the identifier is recorded during the sample preparation and/or sample loading and/or cartridge loading and/or analysis stage;
the identity of the identifier for the sample analysis kit is recorded before the packaging is opened;
the identity of the identifier for the cartridge is recorded before the cartridge is loaded with the sample and/or before the cartridge is loaded into the instrument and/or after.

6. The method of claim 5 wherein the identity of the identifier recorded is used to link the sample analysis kit and/or cartridge and/or container for reagents or materials to one or more of: the sample collection kit, sample collection device, one or more containers in the sample collection kit, sample, person providing the sample or record of information given by or taken from the person providing the sample.

7. The method of claim 1, wherein the results may contain a raw results data file generated by the instrument and the results comprise an identity for an identifier for the results.

8. The method of claim 7, wherein the identity of the identifier included in the results is used to link the results to one or more of: the sample analysis kit, cartridge, container for reagents or materials, the sample collection kit, sample collection device, one or more containers in the sample collection kit, sample, person providing the sample or record of information given by or taken from the person providing the sample.

9. The method of claim 1, wherein in a results processing stage the results file is received and subjected to one or more processing steps to generate one or more processed results.

10. A method according to claim 9, wherein the processed results comprise an identifier and the identifier is used to link the processed results to one or more of: the processing stage, potentially comprising steps and/or criteria used therein, the identity of the identifier included in the results, the sample analysis kit, cartridge, container for reagents or materials, the sample collection kit, sample collection device, one or more containers in the sample collection kit, sample, person providing the sample or record of information given by or taken from the person providing the sample.

11. A kit, the kit being for use in collecting a sample and/or being for use in analysing a sample, the kit comprising:
packaging for one or more devices or containers; and
one or more devices and/or one or more containers; and wherein an identifier is provided on one or more of the devices and/or containers and/or packaging.

12. A kit according to claim 11 wherein the kit comprises: packaging for one or more items, the one or more items comprising a loadable element wherein at least a part of the analysis of the sample is performed.
